(19) United States
(12) Patent Application Publication
(10) Pub. No.: US 2025/0348056 A1
(43) Pub. Date: Nov. 13, 2025

(54) ENSURING BACKWARDS COMPATBILITY BETWEEN A SUPERVISORY SYSTEM AND ON-DEVICE CONTROL SOFTWARE

(71) Applicant: TECHNOLOGICAL RESOURCES PTY LIMITED, Melbourne (AU)

(72) Inventors: Joel CARTWRIGHT, Melbourne (AU); Steven Mark COOK, Melbourne (AU); Christopher INNES, Melbourne (AU)

(21) Appl. No.: 18/870,480

(22) PCT Filed: May 31, 2022
(86) PCT No.: PCT/AU2022/050530

§ 371 Date: Nov. 29, 2024

(51) Int. Cl. G05B 19/4155

(52) U.S. Cl. CPC G05B 19/4155; G05B 2219/32403

(57) ABSTRACT

Disclosed herein are a method and system for providing backwards compatibility between software versions of supervisory system software executing on a supervisory system and on device control software executing on a device under control of the supervisory system, wherein the on device control software executes on a computing module located on the device to act as an intermediary between the supervisory system and device software running on the device. Providing backwards compatibility between software versions enables upgrade schedules to be more flexible and no longer requires the supervisory system and all devices under control of the supervisory system to be upgraded at the same time.

### TECHNICAL FIELD

The present disclosure relates to a method and system for providing backwards compatibility between a supervisory system and on-device automation control software executing on a device under control of the supervisory system and, in particular, to on-device control software executing on a device operating in a primary industry.

### BACKGROUND

A supervisory system is a computer-implemented system for controlling one or more associated devices. Each associated device may be co-located with the supervisory system or alternatively may be located at a remote location, wherein a communication link enables the supervisory system to communicate with the device.

A supervisory system is typically implemented using software executing on a processor, wherein the software provides various functionality for the supervisory system. The particular type of functionality depends on the application, but generally relates to monitoring and control of one or more associated devices.

In one example, a supervisory system for controlling an autonomous machine in the form of a drill rig at a mine site provides a drill control station having a user interface that enables a user to monitor and control operation of an autonomous drill at a mine site. The drill control station may be co-located at, or remote from, the mine site.

In order for the supervisory system to communicate with the device under control of the supervisory system, there needs to be compatibility between the software executing on the supervisory system (the supervisory system software) and the software executing on the device (the device software). In an ideal scenario, the supervisory system software and the device software are developed at the same time to interact with each other and are thus fully compatible. In such a scenario, the version of the supervisory system software is the same as the version of the device software.

In some circumstances, the manufacturer of the supervisory system and the manufacturer of the device are separate entities. In such circumstances, the manufacturer of the supervisory system may develop on-device control software that executes on a computing module located on the device to act as an intermediary between the supervisory system and the device software running on the device. The on-device control software is programmed to interact with the device software, such as by receiving information or data from the device and/or exchanging control signals to control operation of one or more functions of the device. In one example, the supervisory system software and on-device control software are manufactured by a first manufacturer and the device software is manufactured by a second manufacturer, such as a manufacturer of devices, including, for example, drill rigs, trucks, and the like. In such circumstances, it is necessary for the on-device control software to be compatible with the device software and for the on-device control software to be compatible with the supervisory software.

Problems arise due to different development cycles associated with different devices. If a manufacturer of a device releases an updated version of device software operating on devices from that manufacturer, then it may be necessary to update on-device control software executing on computing modules located on devices from that manufacturer in order to continue to interact with the upgraded device software. The updated device software often includes one or more of: new functionality for the device, changes to protocols or commands in relation to existing functionality of the device, or the timing associated with sequencing command signals. Consequently, it is necessary to update the on-device control software to be compatible with the device software. Depending on the changes to the device software and the on-device control software, it may be necessary to upgrade the supervisory system software in order to maintain compatibility with the on-device control software and/or the device software.

In order to maintain full compatibility between the supervisory system software and the on-device control software, it is presently necessary to upgrade the supervisory system software and the on-device control software at the same time. This is extremely problematic for installations across large numbers of supervisory systems and associated devices, particularly where a supervisory system is associated with the control and monitoring of many devices from multiple manufacturers, with each manufacturer operating its own development cycle. Further, it is common for devices associated with a supervisory system to be located remotely from the supervisory system, requiring personnel to travel to the remote site or sites to upgrade the on-device control software on the affected devices. In some situations, such a software upgrade would require taking one or more complete installations offline while the upgrade is effected. In a mining environment, this would require a mine site to be stopped while the on-device control software of each device in turn is upgraded and the associated supervisory systems would need to be upgraded at the same time.

Upgrading all supervisory systems and the on-device control software executing on all of the associated devices at the same time is labour intensive and causes severe disruption to operating capabilities. In the primary industries, in which operations frequently function around the clock, such interruptions can be extremely expensive. Such interruptions can also be dangerous, requiring additional personnel on site to either perform the upgrade to the on-device control software, supervise the upgrade of the on-device control software, or even manoeuvre devices away from an operational position to a maintenance location and then return the devices to an operational location once the upgrades have been completed. Further, upgrading software on all of the supervisory systems and the associated devices at the same time makes it very difficult to trouble-shoot any faults that might arise from rolling out a new software version, as there are so many possible sources of the faults.

Thus, there is a need to provide a method and system that supports backwards compatibility between software versions executing on a supervisory system and on-device control software executing on a device under control of the supervisory system.

### SUMMARY

The present disclosure relates to a method and system for providing backwards compatibility between software versions executing on a supervisory system and on-device control software executing on a device under control of the supervisory system, wherein the on-device control software is configured to interact with device software executing on the device.

A first aspect of the present disclosure provides a method for providing backwards compatibility between a supervisory system and a device to be controlled by said supervisory system, said supervisory system implemented using supervisory system software and said device implemented using on-device control software, wherein the on-device control software is configured to interact with device software executing on the device, the method comprising the steps of:
implementing a supervisory system data translation layer that includes mapping rules for converting serialised objects, key-values, and Events between at least one version of said supervisory system software and at least one version of said on-device control software;
implementing a supervisory system application layer that passes supervisory serialisation information to said supervisory system data translation layer to define serialised objects of said supervisory system;
exchanging automation control protocol message identifiers (IDs) and a definition of key-values during a connection between said supervisory system and said device;
making, by the supervisory system software, a compatibility decision based on said exchanged automation control protocol message IDs;
receiving, by the supervisory system software, device serialisation information from said on-device control software;
enforcing, by said supervisory system software translation layer, key-values based on said full definition of key-values and said compatibility decision;
wherein said supervisory system software translation layer includes mapping rules for converting key-values between a version of said supervisory system software and a version of said on-device control software.

A second aspect of the present disclosure provides a control system comprising:
a supervisory system implemented using supervisory system software; and
a device to be controlled by said supervisory system, said device having an on-device module executing on-device control software, wherein the on-device control software is configured to interact with device software executing on the device;
wherein the supervisory system software implements:
a supervisory system data translation layer that includes mapping rules for converting serialised objects, key-values, and events between at least one version of said supervisory system software and at least one version of said on-device control software; and
a supervisory system application layer that passes supervisory serialisation information to said supervisory system data translation layer to define serialised objects of said supervisory system;
wherein said supervisory system software and said on-device control software are configured to exchange automation control protocol message identifiers (IDs) and a definition of key values during a connection between said supervisory system and said device;
wherein said supervisory system software determines a compatibility decision based on said exchanged automation control protocol message IDs; and
wherein said supervisory system software receives device serialisation information from said on-device control software and enforces, by said supervisory system software translation layer, key-values based on said full definition of key-values and said compatibility decision. According to another aspect, the present disclosure provides an apparatus for implementing any one of the aforementioned methods.

According to another aspect, the present disclosure provides a computer program product including a computer readable medium having recorded thereon a computer program that when executed on a processor of a computer implements any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a schematic representation of a system on which one or more embodiments of the present disclosure may be practised;

FIG. 2 is a schematic representation representing backwards compatibility between a supervisory system and a device in the form of an autonomous drill rig;

FIG. 3 is a schematic block diagram representation of a system that includes a general purpose computer on which one or more embodiments of the present disclosure may be practised; and

FIG. 4 is a schematic representation of a system on which one or more embodiments of the present disclosure may be practised.

Method steps or features in the accompanying drawings that have the same reference numerals are to be considered to have the same function(s) or operation(s), unless the contrary intention is expressed or implied.

### DETAILED DESCRIPTION

The present disclosure relates to a method and system for providing backwards compatibility between software versions of supervisory system software executing on a supervisory system and on-device control software executing on a device under control of the supervisory system, wherein the on-device control software executes on a computing module located on the device to act as an intermediary between the supervisory system and device software running on the device. Providing backwards compatibility between software versions enables upgrade schedules to be more flexible and no longer requires the supervisory system and all devices under control of the supervisory system to be upgraded at the same time.

One approach to ensuring compatibility between a supervisory system and a device is to provide supervisory system software that is backwardly compatible with older versions of on-device control software and, conversely, on-device control software that is backwardly compatible with older versions of supervisory system software. Such an approach provides maximum flexibility, but comes at the cost of unnecessary complexity. In order to provide such backwards compatibility across both the supervisory system software and the on-device control software, each of the supervisory system software and the on-device control software becomes excessively large, potentially incorporating multiple translation engines or look-up tables to enable communication between different software versions executing on the supervisory system and the device.

The method and system of the present disclosure provide a framework that provides backwards compatibility between a supervisory system and on-device control software executing on a device under control of the supervisory system across multiple intermediate software version upgrades, as well as across at least one major software version upgrade. In particular, the method and system prioritise the ability to upgrade supervisory system software over upgrades to on-device control software, such that the supervisory system software is backwardly compatible with on-device control software, but the on-device control software need not be backwardly compatible with major software versions of the supervisory system software. Optionally, the on-device control software is compatible with earlier intermediate software versions of the supervisory system software, but not necessarily with earlier major versions of the supervisory system software.

Supervisory systems are typically implemented on more powerful computers than the computing devices available on devices under control of the supervisory systems on which the on-device control software runs. Consequently, supervisory system software containing additional code to perform backwards compatibility with device software can be readily stored and executed. Devices under control of a supervisory system may be located at remote sites. Consequently, implementing on-device control software as simply as possible facilitates testing and provides greater reliability. Further, it is generally easier to upgrade supervisory system software, which is typically located in a centralised location that may house multiple instances of supervisory systems, such as multiple drill control stations for controlling autonomous drill rigs at one or more remote mine sites. In such environments, the computing devices on which the supervisory system is executing may be readily accessed and upgraded. In contrast, primary industry devices on which on-device control software is executing, such as autonomous drill rigs and the like, are typically located in operational areas that may be difficult to access, with the devices needing to be taken out of operation for any upgrades to be performed.

Further, supervisory systems may have fewer safety issues in relation to access to the site and operating conditions, resulting in better access for software upgrades than upgrading on-device control software running on devices at remote sites. Further still, one supervisory system may control multiple devices, so upgrading supervisory system software requires fewer software installations than upgrading the on-device control software running on all of the devices under control of the supervisory systems.

Practical advantages may be realised from upgrading supervisory system software one supervisory system at a time, enabling testing to be performed to ensure that a new version of the supervisory system software is compatible with whatever on-device control software versions are currently in operation by the devices under control of the supervisory system. Roll-out of the newer version of the supervisory system software to other supervisory system instances can then occur in a planned manner.

In some circumstances, remote operating sites are particularly difficult to access. Under such circumstances, it may be advantageous and even desirable to have devices running an older version of on-device control software that is well-tested and reliable, provided that the older version of on-device control software is sufficiently compatible with the version of supervisory system software being executed by the supervisory systems controlling those devices and, of course, suitably compatible with the device software executing on the relevant devices.

The method and system of the present disclosure provide safety mechanisms to prevent incorrect operation that may result from incompatible software versions. In particular, the method and system prevent operation of a device in the event that there is a detected incompatibility between a supervisory system and on-device control software executing on a device under control of that supervisory system. In some embodiments, the supervisory system software displays an error message, either alone or in combination with one or more of a visual warning and an audible warning, on detection of an incompatibility between the supervisory system software and the on-device control software.

The method and system for providing backwards compatibility will be described herein with reference to the mining industry and, in particular, to the control of a device in the form of an autonomous drill rig by a supervisory system in the form of a drill control station (DCS). However, it will be appreciated by a person skilled in the relevant art that such embodiments are illustrative and not restrictive, and that the method and system of the present disclosure may be equally practised on many other supervisory systems and associated devices under control thereof (including other autonomous or semi-autonomous machinery including vehicles, such as cars, trucks, trains, loaders, crushers, excavators, bulldozers, and the like), wherein the associated devices execute device software and on-device control software executes on a computing device on each associated device to interact with the device software, without departing from the spirit and scope of the present disclosure.

In one embodiment, a control centre is associated with one or more mine sites. The control centre includes a supervisory system in the form of a drill control station that is executing supervisory system software, wherein the drill control station is operated by a drill controller. The drill control station enables the drill controller to monitor and control one or more autonomous vehicles, such as autonomous drill rigs, at one or more of the mine sites. The drill control station is implemented using a computing device having one or more processors on which supervisory system software is executing. The control centre may be located on a mine site or alternatively may be located remotely from the mine site(s) over which the control centre has control. In the context of this disclosure, the control centre is coupled to the autonomous vehicles via at least one wireless communication link.

Autonomous drill rigs perform one or more functions, based on received computer commands, without requiring input from an onboard drill operator. Such functions may include, for example, but are not limited to, tramming to a location for a next hole to be drilled, levelling the drill rig, raising or lowering a mast associated with the drill rig, or drilling a hole, without having a drill operator on board to control operation of the drill rig. Autonomous drill rigs may be conventional blast hole drill rigs that have been retrofitted with automation technology. Alternatively, autonomous drill rigs may be designed from the ground up to function autonomously.

There are multiple manufacturers of drill rigs and each manufacturer develops and implements proprietary device software to execute on a processor of the drill rig. The device software directly controls operation of all functionality of the drill rig. During autonomous operation, it is necessary for the drill rig to be capable of receiving commands from a control centre. In order to do so, on-device control software is introduced that acts as an intermediary between a drill control station at the control centre and the device software executing on the drill rig.

Each autonomous drill rig is equipped with a drill module that utilises on-device control software to interact with the device software in order to monitor and/or control operation of one of more functions of the drill rig. The drill module is implemented using a computing device, such as a programmable logic controller or a general purpose computer programmed to function in a customised way to control one or more functions of the drill rig. In particular, the drill module stores and executes the on-device control software suitable for interacting with device software of the device on which the device software is installed. In this example, the drill module executes on-device control software for interacting with device software of an autonomous drill rig. Different protocols may be utilised for the communication between the on-device control software and the device software, depending on the particular application. Suitable protocols include, for example, but are not limited to: MODBUS TCP; MODBUS RTU; OPC UA; Ethernet/IP; Common Industry Protocol (CIP); or DF1.

The control centre is equipped with one or more drill control stations for controlling operation of drill rigs at one or more mine sites allocated to that control centre. The control centre is coupled to a communications network and sends information and commands via the communications network to devices located at each mine site associated with the control centre. Each mine site may include, for example, a wireless transmitter connected to the communications network and for transmitting wireless signals to drill rigs located at that mine site, with each drill rig being equipped with a wireless receiver. In order for a drill control station to control an autonomous drill rig assigned to that drill control station, it is necessary for the supervisory system software executing on the drill control station to be compatible with the on-device control software executing on the autonomous drill rig.

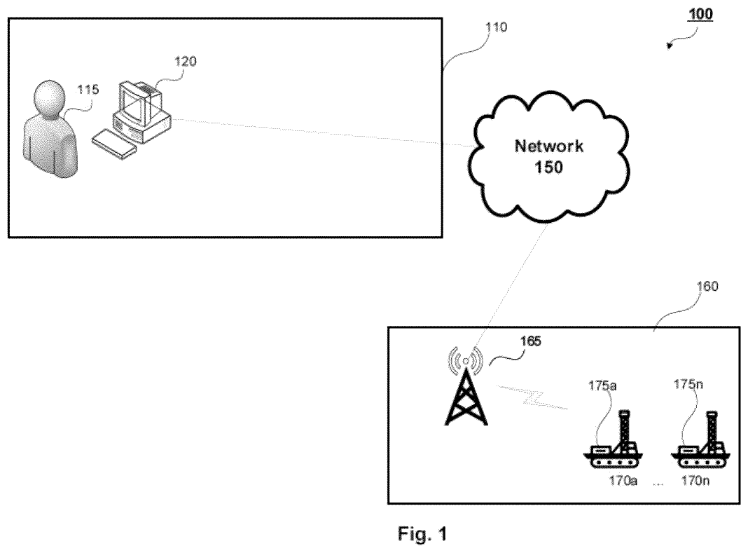

FIG. 1 is a schematic block diagram representation of a system 100 in accordance with the present disclosure. The system 100 includes a remote control centre 110 for remotely operating control of drill rigs at one or more mine sites. The remote control centre 110 includes a supervisory system in the form of a drill control station 120 that is accessed by a drill controller 115 to monitor and control operation of drill rigs at remotely located mine sites. Whilst the example of FIG. 1 shows a single drill control station 120, other embodiments may include multiple drill control stations to allow contemporaneous access by multiple drill controllers. In a large installation, different drill controllers utilise a set of drill control stations to control an allocated set of drill rigs across one or more mine sites.

The remote control centre 110 is coupled to a communications network 150. The communications network 150 may be implemented utilising one or more wired communications links, wireless communications links, or any combination thereof. In particular, the communications network 150 may include a local area network (LAN), a wide area network (WAN), a telecommunications network, or any combination thereof. A telecommunications network may include, but is not limited to, a telephony network, such as a Public Switch Telephony Network (PSTN) or a cellular mobile telephony network, the Internet, or any combination thereof.

In the example of FIG. 1, the system 100 includes a mine site 160 that has a wireless transmitter 165 and a set of n drill rigs 170a . . . n. Depending on the application, the remote control centre 110 may be co-located with the mine site 160 or alternatively may be located remotely, such as at a remotely located operations centre. The wireless transmitter 165 is coupled to the communications network 150 and is configured to communicate wirelessly with each of the drill rigs 170a . . . n. Depending on the implementation, the wireless transmitter 165 may be located at a mine site office or the like and may be implemented using one or more physical transceivers.

Each of the drill rigs 170a . . . n is equipped with a wireless transceiver for communicating with the wireless transmitter 165. The drill rigs 170a . . . n are able to send information, via the wireless transmitter 165 and the communications network 150, back to the remote control centre 110. The information may include, for example, information about the ground conditions, pressure on controls, and other measurement while drilling (MWD) data, such as drill bit pull down pressure and speed.

Further, each of the drill rigs 170a . . . n of FIG. 1 is capable of operating in an autonomous mode, based on instructions received from the remote control centre 110. In autonomous mode, a drill rig may perform one or more functions in accordance with a drilling plan, such as tramming to a location for a next hole to be drilled, raising or lowering a mast associated with the drill rig, or drilling a hole, without having a drill operator on board to control operation of the drill rig. Functionality of each drill rig 170a . . . n is controlled by device software executing on the respective drill rig. The device software is part of the drill rig 170a . . . n, as provided by the drill rig manufacturer(s).

Each of the drill rigs 170a . . . n is equipped with a corresponding drill module 175a . . . n that stores and executes on-device control software for controlling the autonomous functions able to be performed by the respective drill rig. As noted above, each drill rig 170a . . . n is equipped with a wireless transceiver. Depending on the implementation, the wireless transceiver for a drill rig 170a . . . n is either coupled to the respective drill module 175a . . . n or is a component of the drill module 175a . . . n. It is to be noted that each of the drill rigs 170a . . . n may be manufactured by different manufacturers and, consequently, running different device software. The on-device control software executing on the drill modules 175a . . . n is responsible for interfacing between commands received from the drill control station 120 and device software executing on the respective drill rigs 170a . . . n.

The drill control station 120 is implemented using a computing device that executes supervisory system software to provide the drill controller 115 with a user interface by which the drill controller 115 is able to monitor operation of the drills 170a . . . n and send commands to the drill rigs 170a . . . n.

The drill controller 115 is able to access the drill control station 120 to send information and commands, via the communications network 150, to the drill rigs 170a . . . n at the mine site 160. The information and commands may relate, for example, to a drilling plan. Thus, the drill controller 115 is able to utilise the drill control station 120 to prepare and allocate tasks to each of the autonomous drill rigs 170a . . . n.

In order for the drill control station 120 to communicate effectively with each of the drill rigs 170a . . . n, it is necessary for the supervisory system software executing on the drill control station 120 to be compatible with the on-device control software executing on the drill modules 175a . . . n on the corresponding drill rigs 170a . . . n. Further, the on-device control software executing on a particular drill module 175a . . . n needs to be compatible with the device software executing on the drill rig 170a . . . n on which the drill module 175a . . . n is located.

Over time, it becomes necessary or desirable to upgrade the software on either one or both of the drill control station 120 and the autonomous drill rig 170a . . . n. In relation to the autonomous drill rig 170a . . . n, either one or both of the device software or the on-device control software may be upgraded. Such software upgrades may relate, for example, to fix bugs in the software, update drivers for existing functionality, or implement new functionality. For example, a drill rig manufactured by Epiroc may receive a device software update from Epiroc to either fix a software bug, improve functionality, or even add new functionality to the drill rig. The on-device control software executing on a drill module on that Epiroc drill rig may need to be upgraded to maintain compatibility with the updated device software, particularly if the update to the device software changed any communication protocol or command structure.

Depending on the circumstances, it is not always necessary or even desirable to upgrade the supervisory system software executing on the drill control station 120 at the same time as the on-device software executing on the autonomous drill 170a . . . n. For example, upgrading the supervisory system software on the drill control station 120 to implement a new user interface feature may provide a drill operator 115 with a more intuitive interface, but not change the actual control available to the drill operator 115. In such an example, it is useful to limit software upgrades to the drill control station 120. In a situation in which a new function of the autonomous drill rig 170a . . . n has been implemented by the drill manufacturer, then an upgrade of the on-device software on the autonomous drill rig 170a . . . n is required, such that the on-device control software can communicate effectively with the new functionality implemented by the device software of the autonomous drill rig 170a . . . n. An upgrade of the supervisory software on the drill control station 120 to provide the drill operator 115 with the ability to monitor and control the new functionality is also required, but may be made at a later time, depending on the need to access the new functionality.

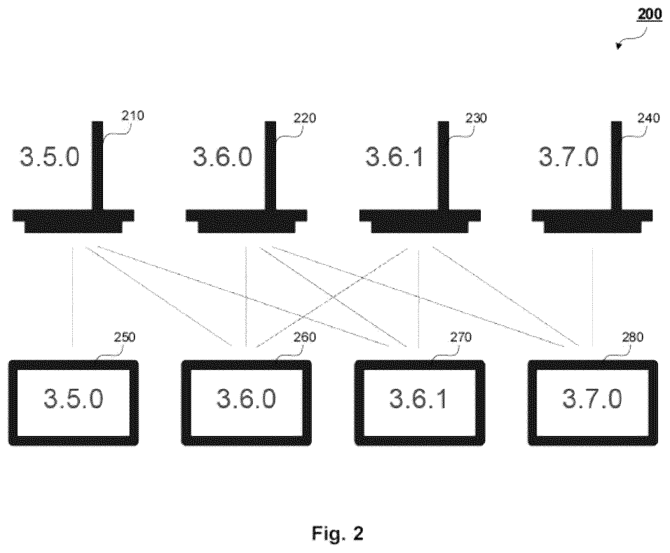

FIG. 2 is a schematic representation 200 illustrating backwards compatibility between on-device control software executing on a device and supervisory software executing on a supervisory control system over time. A first device 210 is running on-device control software version 3.5.0 and is compatible with a first supervisory system 250 running supervisory system software version 3.5.0, as is to be expected. The on-device control software 3.5.0 executing on the first device 210 is also compatible with a second supervisory system 260 running supervisory system software version 3.6.0, a full version upgrade over 3.5.0 executing on the first supervisory system 250. Further, the on-device control software 3.5.0 executing on the first device 210 is compatible with a third supervisory system 270 running supervisory software version 3.6.1, a minor upgrade over the supervisory system software version 3.6.0 executing on the second supervisory system 260. However, the first device 210 running on-device control software version 3.5.0 is not guaranteed to be compatible with a fourth supervisory system 280 running supervisory system software 3.7.0, which is two full versions beyond the on-device control software version 3.5.0 running on the first device 210.

A second device 220 is running on-device control software 3.6.0, corresponding to a full version software upgrade relative to on-device control software 3.5.0 executing on the first device 210. On-device control software 3.6.0 executing on the second device 220 is compatible with each of the second supervisory system 260 running supervisory system software 3.6.0, the third supervisory system 270 running supervisory system software 3.6.1, and the fourth supervisory system 270 running supervisory system software 3.7.0, which is only a single full version upgrade relative to the on-device control software 3.6.0 executing on the second device 220. The on-device control software 3.6.0 executing on the second device 220 is not backwardly compatible with the supervisory system software 3.5.0 executing on the first supervisory system 250.

The third device 230 is running on-device control software 3.6.1, a minor version upgrade relative to on-device control software 3.6.0 running on the second device 220. The on-device control software 3.6.1 executing on the third device 230 is compatible with the second supervisory system 260 running supervisory system software 3.6.0, as the on-device control software 3.6.1 is only a minor version upgrade relative to the supervisory software 3.6.0 executing on the second supervisory system 260. The on-device control software 3.6.1 executing on the third device 230 is also compatible with the third supervisory system 270 running supervisory system software 3.6.1, and the fourth supervisory system 270 running supervisory system software 3.7.0.

The fourth device 240 is running on-device control software 3.7.0, a major upgrade relative to the on-device control software versions executing on each of the first, second, and third devices 210, 220, and 230. The on-device control software 3.7.0 executing on the fourth device 240 is compatible with only the fourth supervisory system 280 running supervisory system software 3.7.0 and is not compatible with any of the first, second, or third supervisory systems 250, 260, 270 running supervisory system software from a previous major version.

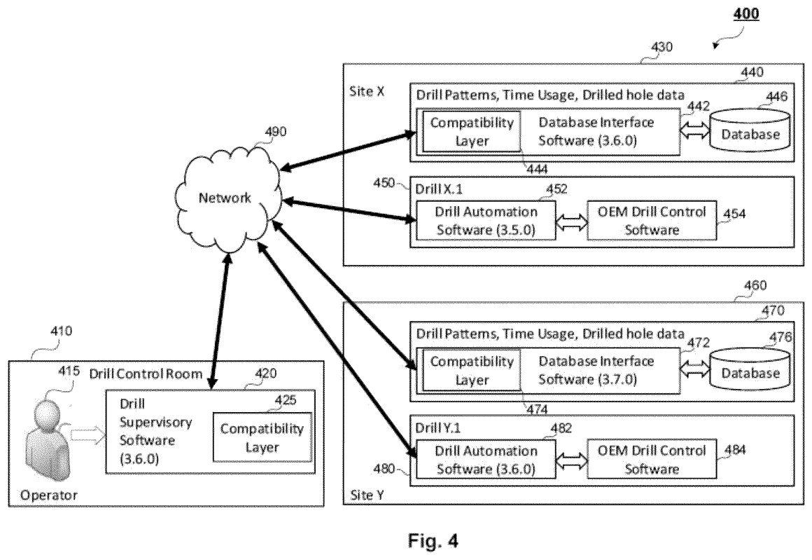

FIG. 4 is a schematic block diagram representation of a system 400 on which a method of backwards compatibility between a supervisory system in the form of a drill control room 410 and multiple drill rigs, being a first drill rig 450 and a second drill rig 480, may be practised.

The drill control room 410 includes a drill control station 420 that may be accessed by a drill operator 415. The drill control station 420 is implemented using a computing device that includes at least one processor on which executes supervisory system software. In the example of FIG. 4, the supervisory system software is Drill Supervisory Software Version 3.6.0. The supervisory system software provides the drill operator 415 with functionality to monitor and control drill rigs associated with the drill control station 420. In order to determine a level of compatibility between the supervisory system software and the associated drill rigs under control of the drill control station 420, the supervisory software includes a compatibility layer 425.

The drill control station 420 is coupled to a communications network 490. The communications network 490 may be implemented utilising one or more wired communications links, wireless communications links, or any combination thereof. In particular, the communications network 490 may include a local area network (LAN), a wide area network (WAN), a telecommunications network, or any combination thereof. A telecommunications network may include, but is not limited to, a telephony network, such as a Public Switch Telephony Network (PSTN) or a cellular mobile telephony network, the Internet, or any combination thereof.

The system 400 of FIG. 4 includes two mine sites in the form of Site X 430 and Site Y 460. Site X 430 has a Drill X.1 450 that is running device software in the form of OEM Drill Control Software 454. The OEM Drill Control Software 454 is software installed by the manufacturer of Drill X.1 450 and which controls functionality of Drill X.1 450. Drill X.1 450 also has a first drill module 452 executing on-device software in the form of Drill Automation Software Version 3.5.0. The Drill Automation Software Version 3.5.0 acts as an interface between the Drill Supervisory Software executing on the drill control station 420 and the OEM Drill Control Software 454, such that the drill control station 420 can monitor and control operation of Drill X.1 450. The Drill Automation Software Version 3.5.0 executing on the first drill module 452 receives commands from the Drill Supervisory Software executing on the Drill Control Station 420. On receipt of the commands, the Drill Automation Software Version 3.5.0 needs to understand the received commands and then implement the received commands by sending instructions to the OEM Drill Control Software 454. As will be readily understood, the instructions sent to the OEM Drill Control Software 454 may be different for each manufacturer of drill rigs, as each manufacturer will likely have its own proprietary instruction set for controlling the drill rig.

Drill X.1 450 is coupled to the communications network 490. In one implementation, Drill X.1 450 includes a wireless transceiver for communicating with a wireless transmitter (not shown) located on Site X 430, wherein the wireless transmitter is coupled to the communications network 490. In one implementation, the wireless transceiver forms part of the first drill module 452. In another implementation, the wireless transceiver is coupled to the first drill module 452. In a further implementation, Drill X.1 450 includes a built-in wireless transceiver coupled to the OEM Drill Control Software 454 and a second wireless transceiver coupled to the first drill module 452.

Site X 430 has an associated Site X Database Server 440 that is coupled to the communications network 490. The Site X Database Server 440 stores drilling data relating to drilling operations at Site X. Such drilling data may include, for example, but is not limited to, drill patterns, time usage, and drilled hole data. The drilling data may be distributed to drills at Site X and associated drill control stations. The drilling data may also be used for reporting purposes.

In the example of FIG. 4, Site X Database Server 440 is shown at Site X, but in practice the Site X Database Server 440 may be located anywhere, including being co-located with the drill control room 410 or as a cloud-based storage system. The Site X Database Server 440 in the example of FIG. 4 is running Database Interface Software Version 3.6.0. The Site X Database Server 440 includes a Compatibility Layer Module 444 and is coupled to a Site X database 446.

Site Y 460 has a Drill Y.1 480 that is running device software in the form of OEM Drill Control Software 484. The OEM Drill Control Software 484 is software installed by the manufacturer of Drill Y.1 480 and which controls functionality of Drill Y.1 480. Drill Y.1 480 also has a second drill module 482 executing on-device software in the form of Drill Automation Software Version 3.6.0. The Drill Automation Software Version 3.6.0 acts as an interface between the Drill Supervisory Software executing on the drill control station 420 and the OEM Drill Control Software 484, such that the drill control station 420 can monitor and control operation of Drill Y.1 480. The Drill Automation Software Version 3.6.0 executing on the second drill module 482 receives commands from the Drill Supervisory Software executing on the Drill Control Station 420. On receipt of the commands, the Drill Automation Software Version 3.6.0 needs to understand the received commands and then implement the received commands by sending instructions to the OEM Drill Control Software 484. As will be readily understood, the instructions sent to the OEM Drill Control Software 484 may be different for each manufacturer of drill rigs, as each manufacturer will likely have its own proprietary instruction set for controlling the drill rig.

Drill Y.1 480 is coupled to the communications network 490. In one implementation, Drill Y.1 480 includes a wireless transceiver for communicating with a wireless transmitter (not shown) located on Site Y 460, wherein the wireless transmitter is coupled to the communications network 490. In one implementation, the wireless transceiver forms part of the second drill module 482. In another implementation, the wireless transceiver is coupled to the second drill module 482. In a further implementation, Drill Y.1 480 includes a built-in wireless transceiver coupled to the OEM Drill Control Software 484 and a second wireless transceiver coupled to the second drill module 482.

Site Y 460 has an associated Site Y Database Server 470 that is coupled to the communications network 490. The Site Y Database Server 470 stores drilling data relating to drilling operations at Site Y. Such drilling data may include, for example, but is not limited to, drill patterns, time usage, and drilled hole data.

In the example of FIG. 4, Site Y Database Server 470 is shown at Site Y, but in practice the Site Y Database Server 470 may be located anywhere, including being co-located with the drill control room 410 or as a cloud-based storage system. The Site Y Database Server 470 in the example of FIG. 4 is running Database Interface Software Version 3.7.0. The Site Y Database Server 470 includes a Compatibility Layer Module 474 and is coupled to a Site Y database 476.

During operations of the mine sites Site X 430 and Site Y 460, the drill operator 415 accesses a user interface provided by the Drill Supervisory Software 3.6.0 executing on the drill control station 420. The user interface provides the drill operator 415 with the ability to monitor and control Drill X.1 450 at Site X 430 and Drill Y.1 480 at Site Y 460, as the Drill Supervisory Software 3.6.0 communicates with the Drill Automation Software 3.5.0 of Drill X.1 450 and the Drill Automation Software 3.6.0 of Drill Y.1 480. The Drill Supervisory Software 3.6.0 also communicates with each of the Site X Database Server 440 and the Site Y Database Server 470 to receive and store drilling data relating to the respective mine sites Site X 430 and Site Y 470.

In order for the drill control station 420 to be able to continue to monitor and control Drill X.1 450 and Drill Y.1 480, the system and method of the present disclosure determine a level of compatibility between different nodes in the system, wherein the nodes of the system of FIG. 4 are the drill control station 420, Drill X.1 450, Drill Y.1 480, Site X Database Server 440, and Site Y Database Server 470. Each of the nodes has an associated compatibility layer that is utilised during an initial communication exchange with another node to determine a level of compatibility.

For example, during an initial communication between the drill control station 420 and Drill X.1 450, the compatibility layer 425 within the Drill Supervisory Software 3.6.0 communicates with the first drill module 452 running Drill Automation Software 3.5.0 to determine a level of level of compatibility between the versions of software running respectively on the drill control station 420 and Drill X.1 450.

### Automation Control Protocol

An automation control protocol is utilised for administering communications between a supervisory system and an autonomous device to be controlled by the supervisory system. In current implementations, the automation control protocol is rigid, with an exact version match required between respective endpoints (i.e., the supervisory system and device) in order for successful communication to occur.

In some embodiments, a backwardly compatible method and system control amendments to an automation control protocol utilised for communications between a supervisory system and a device to be controlled. When a supervisory system and device connect using an automation control protocol, each of the supervisory system and device, respectively, report message identifiers (IDs) that are understood.

The nodes of a system make a compatibility decision based on supported message identifiers. That is, in the context of FIG. 1, the drill control station 120 and the drill rigs 170a . . . n under supervision of the drill control station 120 determine a level of compatibility based on exchanged supported message identifiers. The level of compatibility between the drill control station 120 and each of the drill rigs 170a . . . n may be different, depending on the level of compatibility between the version of supervisory system software executing on the drill control station 120 and the versions of on-device control software executing on the drill modules 175a . . . n of the respective drills 170a . . . n.

In one implementation, the on-device control software executing on each of the drill modules 175a . . . n of the respective drills 170a . . . n sends a “capabilities message” to the supervisory system software executing on the drill control station 120. The capabilities message includes a definition of a set of key-values, events, and serialised objects for the on-device control software. The definitions include not only an identifier, but other relevant properties. The properties depend on the particular object, but may include, for example, severity, message, attached data types, type information and the like. For example, the set of key-values contains property data that describe the key and associated value(s). An example of a key-value might be, for example:
Key: Feedback.RotationPressure
Value: 21454.34
Type: double
Precision: 5

The supervisory system software receives the capabilities message and a translation layer (also referred to as a compatibility layer) makes a determination of the level of compatibility. In particular, the translation layer determines whether:
A. The translation layer can appropriately process all events and key-values received from the on-device control software required for the supervisory system software to operate.
B. All Events potentially sent from the supervisory system to the drill will be compatible with the on-device control software.
C. The translation layer can appropriately serialise and de-serialise objects to and from the on-device control software.

Initially, the translation layer examines whether “Pass-through” rules can be established between the on-device control software and the supervisory system software. That is, the supervisory software examines its own definition of key-values and events and determines if a direct mapping can be made automatically. Typically, this is when there has been no change in the definitions of these messages.

If a pass-through mapping cannot be achieved, the supervisory system software then checks whether a translation rule has been defined that specifies how to convert the events and/or key-values so that the events and/or key-values can be understood correctly by the supervisory system software for key-values and/or events coming from the on-device control software and, conversely, by the on-device control software for events and/or key-values coming from the supervisory system software.

Translation rules are managed during updates to the supervisory system software and, when provided, are embedded in the translation layer. During subsequent updates of the supervisory system software, any outdated translation rules may be deleted.

In some embodiments, the supervisory system software executing on a supervisory system and on-device control software executing on a device to be controlled by the supervisory system exchange message identifiers (IDs). When the respective versions of the supervisory system software and on-device control software are fully compatible, then the exchanged message IDs will match and all functionality is available.

When there is a discrepancy in the message IDs, arising from different versions of the supervisory system software and the on-device control software, then the supervisory system software and on-device control software ignore any unsupported message IDs and continue to process message IDs that are supported by both the supervisory system software and the on-device control software. In instances when the supervisory system software or on-device control software receives an unsupported message ID, the respective software logs an error. Logging an error may include storing an error message in an error database stored on a computer-readable storage medium, transmitting an error message to a central computing device, or a combination thereof. Logging an error may also include generating an alert, such as an error message to be displayed on a display device of a computing device forming the supervisory system or device, or an audible tone, or a combination thereof.

### Handling Old Data

Backwards compatibility between supervisory system software and on-device control software executing on devices under control of the supervisory system requires that old data be understood by newer supervisory system software versions. Such data may include, for example, serialised objects, Events, and key-values. Key-values are parameters or variables encoded within the software. During evolution of software releases, it may be necessary or desirable to change key names, which may also be referred to as key-value identifiers.

The key requirements are that the supervisory system software is able to understand old data sent from on-device control software executing on a device and that the supervisory system software only sends data to the device in a form that will be understood by the version of on-device control software executing on the device.

In some embodiments, a data translation layer is implemented at a low level in the communications stack of the supervisory system software. The supervisory system software (SSS) data translation layer:
understands all old and new serialised object formats it is required to translate
includes explicit mapping rules added on code change, which indicate how to convert serialised objects, key-values, and Events
SSS application layer passes information to translation layer to fully define its serialised objects (including fields used), key-values (only those sent and handled), and Events (only those sent and handled)
receives information from the on-device control software to fully define serialised objects (including fields used), key-values (all), and Events (all, including the message format specifiers)
on receipt from the on-device control software, Events not explicitly handled by the supervisory system software are converted to preformatted events for logging and/or display
the SSS translation layer determines if the supervisory system software and on-device control software are compatible before further interaction is permitted by the supervisory system software

Table 1 shows an example of backwards compatibility implemented using a data translation layer (i.e., “compatibility layer”), illustrating a mapping of changes to key-values between an on-device control software version 3.5.0 and a supervisory system software version 3.6.0.

TABLE 1
Key Translation

| New or | | | |
|---|---|---|---|
| Changed DC | On-device control | | Supervisory System |
| Key | software (3.5.0) | Translation Layer | Software (3.6.0) |
| Key renamed | Feedback.DrillLights | Direct Remapping, | Feedback.Lights |
| | (boolean) | Feedback.DrillLights -> | (boolean) |
| | | Feedback.Lights | |
| New Key | Not present | Set default value in Supervisory | Capability. |
| | | System. | JackPressureSensor |
| | | Capability.JackPressureSensor = | (boolean) |
| | | False | |
| Key Type | Feedback.CollarX | Convert from 3 individual | Feedback.CollarXYZ |
| changed and | (double) | floating point values to a single | (double array of size 3) |
| renamed | Feedback.CollarY | key with an array of size 3. | |
| | (double) | Feedback.CollarXYZ[0] = | |
| | Feedback.CollarZ | Feedback.CollarX | |
| | (double) | Feedback.CollarXYZ[1] = | |
| | | Feedback.CollarY | |
| | | Feedback.CollarXYZ(2] = | |
| | | Feedback.CollarZ | |
| Key deleted | Feedback.DrainPressure | Discarded | Not present |

Table 2 shows an example of backwards compatibility implemented using a data translation layer (i.e., “compatibility layer”), illustrating a mapping of changes to events between an on-device control software version 3.5.0 and a supervisory system software version 3.6.0.

TABLE 2
Event Translation

| New or | | | |
|---|---|---|---|
| Changed | | | |
| Event | On-device control | | Supervisory System |
| Behaviour | software (3.5.0) | Translation Layer | Software (3.6.0) |
| Rename | DeckWrenchNotInDrilling | Create new | DeckSpannerNotInDrilling |
| event | Position | DeckSpannerNotInDrillingPosition | Position |
| | Event | Event copy properties and drop old | Event |
| | | event. | |
| | | DeckSpannerNotInDrillingPosition.properties = | |
| | | DeckWrenchNotInDrillingPosition.properties | |
| Additional | DrilledHoleStatus Event | Add default values for additional | DrilledHoleStatus Event |
| information | | properties | |
| in event from | | | |
| Drill | | | |
| Automation | | | |
| Software | | | |
| Additional | DrilledHoleStatus Event | Remove additional properties. | DrilledHoleStatus Event |
| information | | | |
| in event from | | | |
| Drill | | | |
| Supervisory | | | |
| System | | | |
| Event Added | — | Discarded | OperatorLoginEvent |

### Solutions-Serialised Objects

Embodiments of the present disclosure utilise boost serialisation to convert C++ (nested) objects to binary representations that can be exchanged between supervisory system software and on-device control software for interacting with device software executing on a device. Serialised objects are exchanged via key-values and in Event parameters, in addition to being used internally within the supervisory system software and the on-device control software, such as, for example, passing parameters between internal software modules.

The supervisory system software defines a fixed set of serialised object IDs:
serialised object IDs should never be reused: reserve IDs on removal
unknown serialised object IDs should be handled gracefully or ignored

Further, some embodiments of the present disclosure utilise a data serialisation protocol, such as Protobuf or FlatBuffers, to ensure that the serialisation wire format does not change in the future. Some particular embodiments utilise Flatbuffers. As FlatBuffers supports extensible messages with optional fields, backwards compatibility is achieved by extending serialised object messages:
add fields as the object changes (must keep old fields)
on-device control software sends a full set of dummy example messages to the supervisory system software on connection, which the supervisory system software utilises to determine the message level of the on-device control software and implements an appropriate bi-directional translation
supervisory system software and on-device control software application level code only ever sees messages in their current expected format
translation needs to occur for all exchanged serialised objects (depending on the implementation, it may be necessary to add an Event parameter type “object” to achieve this translation)

In addition to extension of messages, further embodiments optionally add an entirely new serialised object message to replace a previous message. In one implementation, mapping rules are defined in the supervisory system software translation layer to handle the new serialised object message. It will be appreciated that other embodiments utilising Protobuf or other data serialisation protocols may equally be practised.

### Solutions—Shared Key-Values

Shared key-values facilitate bidirectional translation between supervisory system software and on-device control software key-value definitions. When communication is being established between a supervisory system and a device, the on-device control software executing on the device sends a full definition of key-values to the supervisory system software executing on the supervisory system. The full definition of key-values includes: supported types, keys (ID, name, type). The supervisory system software application layer passes information to the translation layer of keys sent (via manual Events) and received in the supervisory system version of the drill control station: supported types, keys (ID, name, type).

The supervisory system software translation layer enforces the supervisory system key-values list and blocks any attempted use of other keys outside of the supervisory system key-values list, for safety.

The supervisory system software translation layer includes explicit mapping rules added on code changes that indicated how to convert key-values between old and new versions.

For example, for M: N mappings, which are bidirectional if M==N:
SomeBadName double to SomeBetterName double
SomePosition{N,E,U} double to SomePosition DCDouble3 NEU
JackIndicator{RL,RR,FL,FR} bool to JackRetractedCount int

Conversion functions as part of the mapping to support arbitrary manipulation of values. “Ignore” rules explicitly state that a new key is not required to be present on an older version of on-device control software. “Incompatible” rules explicitly state that a given key may not be present on the on-device control software.

Embodiments utilise automatic mapping rules for key-values that match between the supervisory system software and the on-device control software.

Based on the above, the supervisory system software determines a compatibility level of a device to be controlled by the supervisory system and performs bidirectional translation of key-values. Key-values of type “BinaryData” are passed to the serialised object code for an appropriate translation.

### Solutions—Shared Events

Shared Events facilitates bidirectional translation between supervisory system software and on-device control software Event definitions. On connection, on-device control software sends to the supervisory system software a full definition of Events recognised by the on-device control software: (name, property names and types, message format string). The supervisory system software application layer passes information to the supervisory system software translation layer of just those Events that are explicitly sent or handled: (name, property names and types).

The supervisory system software translation layer includes explicit mapping rules added on code changes that indicate how to convert Events between compatible software versions. For 1:1 unidirectional mappings:
SomeBadName (Debug) to SomeBetterName (Info)
GroundDetection(Info, double Depth, bool explicitGround) to
GroundDetection(Info, double Depth)

Conversion functions as part of the mapping to support arbitrary manipulation of properties. “Ignore” rules explicitly state that a new Event is not required to be present on an older version of the on-device control software. “Incompatible” rules explicitly state that a given Event may not be present on the on-device control software version.

Automatic mapping rules are added for Events where the definitions match. Automatic mapping rules are added for Events defined on the on-device control software, but not included in the explicit list from the supervisory system software. These automatic rules convert the Events in question to generic preformatted Events of the same severity, using the message format provided by the on-device control software.

Based on the above, the supervisory system software translation layer determines a level of compatibility of the on-device control software version relative to the version of the supervisory system software and performs bidirectional translation of Events.

Optionally, the supervisory system software is blocked from emitting Events that the supervisory system software did not report to the translation layer.

Event properties with type “object” are passed to the serialised object code for an appropriate translation.

### Database Server

The database server currently uses the device automation control protocol, but not all of the same automation control protocol processing code as the supervisory system software. Unknown automation control protocol message IDs that are received by the database server are ignored and the database server searches for a next valid packet to process.

Database event messages exchanged with the database server are serialised objects, so a change of serialisation library to FlatBuffers requires a change to the serialised objects.

An upgraded database server for use in a backwards compatible system utilises a new automation control protocol message ID for the new serialisation format, enabling the database server to reply in kind to old and new clients, wherein the clients are both the supervisory control system and the on-device/drill control system

As the database server is upgraded first, then new clients (i.e., devices) do not need to include any old serialisation capability.

In order to implement backwards compatibility, the database server extends existing database event messages by adding properties, where such additional properties are sufficient to implement new functionality. Otherwise, add new database event query/response message pairs, retaining support for any existing message pairs in order to support use with older clients. Any unused event properties and messages are optionally removed in later full version upgrades.

### Computer Implementation

The method and system described herein provide a structure that ensures backwards compatibility between a supervisory system and on-device control software executing on a device to be controlled by that supervisory system.

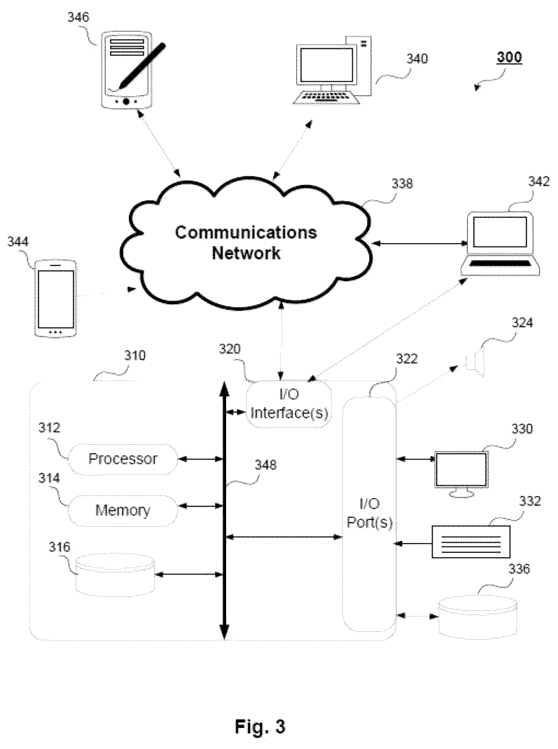

The supervisory system and drill module of the present disclosure may be practised using one or more computing devices, such as a general purpose computer or computer server programmed and adapted to function in an improved manner. FIG. 3 is a schematic block diagram representation of a system 300 that includes a general purpose computer 310. The general purpose computer 310 includes a plurality of components, including: a processor 312, a memory 314, a storage medium 316, input/output (I/O) interfaces 320, and input/output (I/O) ports 322. Components of the general purpose computer 310 generally communicate with each other using one or more buses 348.

The memory 314 may be implemented using Random Access Memory (RAM), Read Only Memory (ROM), or a combination thereof. The storage medium 316 may be implemented as one or more of a hard disk drive, a solid state “flash” drive, an optical disk drive, or other storage means. The storage medium 316 may be utilised to store one or more computer programs, including an operating system, software applications, and data. In one mode of operation, instructions from one or more computer programs stored in the storage medium 316 are loaded into the memory 314 via the bus 348. Instructions loaded into the memory 314 are then made available via the bus 348 or other means for execution by the processor 312 to implement a mode of operation in accordance with the executed instructions.

One or more peripheral devices may be coupled to the general purpose computer 310 via the I/O ports 322. In the example of FIG. 3, the general purpose computer 310 is coupled to each of a speaker 324, a display device 330, an input device 332, and an external storage medium 336. The speaker 324 may be implemented using one or more speakers, internal to the computing device 310 or external to the computing device 310, such as in a stereo or surround sound system, wherein the speakers may be utilised to issue audible alerts and the like.

The display device 330 may be a computer monitor, such as a cathode ray tube screen, plasma screen, or liquid crystal display (LCD) screen. The display 330 may receive information from the computer 310 in a conventional manner, wherein the information is presented on the display device 330 for viewing by a user. The display device 330 may optionally be implemented using a touch screen to enable a user to provide input to the general purpose computer 310. The touch screen may be, for example, a capacitive touch screen, a resistive touchscreen, a surface acoustic wave touchscreen, or the like. In the example in which the general purpose computer 310 is utilised to implement the drill control station 120 of FIG. 1, the display device 310 may display a user interface for receiving inputs from the drill controller 115 and displaying information relating to the operation and control of the drill rigs 170a . . . n.

The input device 332 may be a keyboard, a mouse, a stylus, drawing tablet, or any combination thereof, for receiving input from a user. The external storage medium 336 may include an external hard disk drive (HDD), an optical drive, a floppy disk drive, a flash drive, solid state drive (SSD), or any combination thereof and may be implemented as a single instance or multiple instances of any one or more of those devices. For example, the external storage medium 336 may be implemented as an array of hard disk drives.

The I/O interfaces 320 facilitate the exchange of information between the general purpose computing device 310 and other computing devices. The I/O interfaces may be implemented using an internal or external modem, an Ethernet connection, or the like, to enable coupling to a transmission medium. In the example of FIG. 3, the I/O interfaces 322 are coupled to a communications network 338 and directly to a computing device 342. The computing device 342 is shown as a personal computer, but may be equally be practised using a smartphone, laptop, or a tablet device. Direct communication between the general purpose computer 310 and the computing device 342 may be implemented using a wireless or wired transmission link.

The communications network 338 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 310 is able to communicate via the communications network 338 to other computing devices connected to the communications network 338, such as the mobile telephone handset 344, the touchscreen smartphone 346, the personal computer 340, and the computing device 342.

One or more instances of the general purpose computer 310 may be utilised to implement a drill control station, site controller, remote centre controller, and/or drill module in accordance with the present disclosure. In such an embodiment, the memory 314 and storage 316 are utilised, depending on the particular application, to store one or more of supervisory system software, device software, and data relating to the configuration of drills at one or more mine sites.

### INDUSTRIAL APPLICABILITY

The arrangements described are applicable to primary industries and, in particular, to the mining industry.

Although the invention has been described with reference to specific examples, it will be appreciated by those skilled in the art that the invention may be embodied in many other forms. The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Reference throughout this specification to “one embodiment,” “an embodiment,” “some embodiments,” or “embodiments” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

While some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practised without these specific details. In other instances, well-known methods, structures and techniques have not been shown in detail in order not to obscure an understanding of this description.

Note that when a method is described that includes several elements, e.g., several steps, no ordering of such elements, e.g., of such steps is implied, unless specifically stated.

The term “coupled” should not be interpreted as being limitative to direct connections only. The terms “coupled” and “connected,” along with their derivatives, may be used. It should be understood that these terms are not intended as synonyms for each other, but may be. Thus, the scope of the expression “a device A coupled to a device B” should not be limited to devices or systems wherein an input or output of device A is directly connected to an output or input of device B. It means that there exists a path between device A and device B which may be a path including other devices or means in between. Furthermore, “coupled to” does not imply direction. Hence, the expression “a device A is coupled to a device B” may be synonymous with the expression “a device B is coupled to a device A”. “Coupled” may mean that two or more elements are either in direct physical or electrical contact, or that two or more elements are not in direct contact with each other but yet still co-operate or interact with each other.

1. A method for providing backwards compatibility between a supervisory system and a device to be controlled by said supervisory system, said supervisory system implemented using supervisory system software and said device implemented using on-device control software, wherein the on-device control software is configured to interact with device software executing on the device, the method comprising the steps of:
implementing a supervisory system data translation layer that includes mapping rules for converting serialised objects, key-values, and events between at least one version of said supervisory system software and at least one version of said on-device control software;
implementing a supervisory system application layer that passes supervisory serialisation information to said supervisory system data translation layer to define serialised objects of said supervisory system;
exchanging automation control protocol message identifiers (IDs) and a definition of key-values during a connection between said supervisory system and said device;
making, by the supervisory system software, a compatibility decision based on said exchanged automation control protocol message IDs;
receiving, by the supervisory system software, device serialisation information from said on-device control software;
enforcing, by said supervisory system software translation layer, key-values based on said full definition of key-values and said compatibility decision.

2. The method according to claim 1, wherein said supervisory system software prohibits operation of at least one function of said device upon determining an incompatibility between a current version of said supervisory system software and a current version of said on-device control software.

3. The method according to claim 1,
wherein said supervisory system is a control station and said device is one of an autonomous vehicle and a semi-autonomous vehicle.

4. The method according to claim 3, wherein the device is an autonomous vehicle selected from the group consisting of: cars, trucks, trains, loaders, crushers, excavators, bulldozers, and drill rigs.

5. The method according to claim 4, wherein said control station is a drill control station and said autonomous vehicle is a drill rig.

6. The method according to claim 5, wherein said on-device control software executes on a drill module located on said drill rig to interact with said device software executing on said drill rig.

7. The method according to claim 1, wherein said on-device control software facilitates communication between said supervisory system software and said device software executing on said device, said device software being integral to said device and controlling functionality of said device.

8. The method according to claim 1, wherein each key-value contains property data that describe the key and values associated with that key-value.

9. The method according to claim 1, comprising the further step of:
utilising a data serialisation protocol to control changes to a serialisation wire format.

10. A control system comprising:
a supervisory system implemented using supervisory system software; and
a device to be controlled by said supervisory system, said device having an on-device module executing on-device control software, wherein the on-device control software is configured to interact with device software executing on the device;
wherein the supervisory system software implements:
a supervisory system data translation layer that includes mapping rules for converting serialised objects, key-values, and events between at least one version of said supervisory system software and at least one version of said on-device control software; and
a supervisory system application layer that passes supervisory serialisation information to said supervisory system data translation layer to define serialised objects of said supervisory system;
wherein said supervisory system software and said on-device control software are configured to exchange a capabilities message during a connection between said supervisory system and said device, said capabilities message including automation control protocol message identifiers (IDs) and a definition of key-values;
wherein said supervisory system software determines a compatibility decision based on said exchanged automation control protocol message IDs; and
wherein said supervisory system software receives device serialisation information from said on-device control software and enforces, by said supervisory system software translation layer, key-values based on said full definition of key-values and said compatibility decision.

11. The system according to claim 10, wherein said supervisory system software prohibits operation of at least one function of said device upon determining an incompatibility between a current version of said supervisory system software and a current version of said on-device control software.

12. The system according to claim 10,
wherein said supervisory system is a control station and said device is one of an autonomous vehicle and a semi-autonomous vehicle.

13. The system according to claim 12, wherein the device is an autonomous vehicle selected from the group consisting of: cars, trucks, trains, loaders, crushers, excavators, bulldozers, and drill rigs.

14. The system according to claim 12, wherein said control station is a drill control station and said device is a drill rig.

15. The system according to claim 14, wherein said on-device control software executes on a drill module located on said drill rig to interact with said device software executing on said drill rig.

16. The method according to claim 10, wherein said on-device control software facilitates communication between said supervisory system software and said device software executing on said device, said device software being integral to said device and controlling functionality of said device.

17. The system according to claim 10, wherein each key-value contains property data that describe the key and values associated with that key-value.

18. The system according to claim 10, wherein a data serialisation protocol governs changes to a serialisation wire format.

19. The system according to claim 10, wherein the on-device module is implemented using one of a programmable logic controller and a general purpose computing device storing instructions for executing to control one or more functions of the device by interacting with said device software.

20. The system according to claim 10, further comprising:
a communications network to which each of said supervisory system and said device is coupled,
wherein said device includes a wireless transceiver for coupling said device to said communications network.
